(19) United States
(12) Patent Application Publication
(10) Pub. No.: US 2010/0213014 A1
(43) Pub. Date: Aug. 26, 2010

(54) ELEVATOR DOOR WITH A SET OF LANDING DOORS AND CAR DOORS WITH REDUCED THICKNESS AS A REPLACEMENT FOR EXISTING DOORS

(76) Inventors: Pascal Jolly, Saint Benoit Sur Loire (FR); David Pillin, Saint-Brisson Sur Loire (FR); Daniel Brion, Nevoy (FR)

Correspondence Address: CARLSON GASKEY & OLDS, 400 W MAPLE STE 350, BIRMINGHAM, MI, 48009, US

(21) Appl. No.: 12/294,941

(22) PCT Filed: Jul. 28, 2005
(86) PCT No.: PCT/IB2005/002604

§ 371 Date: Sep. 29, 2008

(51) Int. Cl. B66B 13/08; B23P 6/00

(52) U.S. Cl. 187/330; 187/332; 29/402.03

(57) ABSTRACT

The invention relates to a set of landing doors (19) and elevator car doors (21) as a replacement for existing swing doors without requiring any substantial masonry work, any change in the structure of the car or in the displacement of the latter, the space between the car frame (13) and the landing access opening frame (3) being of 125 mm at the most, characterized in that it comprises a set of landing doors (19) positioned just behind the landing access opening frame (3) and provided with a set of one panel and two telescopic panels with a central opening, the total thickness of which is reduced, and a set of car doors (21) mounted on the elevator car, with a configuration analogous to the set of landing doors (19) and intended to come face-to-face with the latter, within the space (9′), at each building storey landing, in said space of 125 mm between the car frame (13) and the landing access opening frame (3).

The present invention relates to an elevator door with a set of landing doors and car doors with reduced thickness as a replacement for existing doors.

It is known that old elevators comprise landing doors and possibly car doors, such as swing doors which do not have the present required security levels. However, the space between the car frame and the corresponding landing access wall in the shaft is small and the setting up of landing doors and elevator car doors is relatively difficult to achieve generally requiring, because of the large thickness of the doors, the cutting-out of masonry units, or a structural part of the car when there is no question of displacing it.

The invention is directed to finding a remedy to these drawbacks and proposes an elevator door comprising a set of landing doors and elevator car doors specially as a replacement for existing swing doors without requiring substantial masonry work, for changing the structure of the car or displacing the latter, wherein the space between the car frame and the landing access opening frame can be small and being generally of about 125 mm at the most, characterized in that it comprises a set of landing doors positioned just behind the landing access opening frame and provided with a set of one panel and two telescopic panels with a central opening, the total thickness of which can be reduced, and a set of car doors mounted on the elevator car, with a configuration analogous to the set of landing doors and intended to move and face the latter, within the space, at each building storey landing in said space (generally of about 125 mm) between the car frame and the landing access opening frame.

Optionally, a portion of the car front wall may be cut out without reaching the car frame, by suitably adapting the space between the landing doors and the car doors.

In addition, a new car front wall may be mounted.

Said space between the landing doors and the car doors is standard, lying between about 15 and 35 mm, and preferably is equal to about 25 mm, the thickness of each set of landing doors and car doors being of about 50 mm at the most to match said space of about 125 mm between the car frame and the landing access opening frame.

Advantageously, the three panel door is of the same width as the original swing doors.

With the use of three-panel doors, it is possible to limit the opening extension width of the latter and so the setting-up space of the latter behind the landing access opening frame. This space has a maximum width of about 5 times the width of the door clearance divided by 3 (5OP/3). This is less than that for a two-panel door with a central opening (2OP). In addition, because of its thickness, a four-panel door with a central opening would not be able to be mounted within the existing space of the original swing door.

In addition, with this configuration of doors with one and two telescopic panels in opposition, it is possible to form an available space behind the unique panel positioned frontward, being used to house, behind the landing panel, the landing door lock components and behind the car panel, the coupling device of the car doors.

Moreover, the slow panels may be driven by their supporting carriage on a same track of the corresponding supporting lintel and the fast panel may be driven by its supporting carriage on a second lintel track, so that the wheels of these carriages may be positioned on each of these rails more freely and therefore at a center distance notably larger than the conventional one of substantially the width of a panel, which is relatively small, from about 250 to 300 mm for door openings of about 700 to 800 mm. This increased center distance of the wheels improves guiding and stability of the door panels.

This second track or guide rail of the fast panel carriage is preferably positioned above the first track or guide rail of the slow panel carriages, so that the thickness of the corresponding lintel supporting the doors may be reduced.

The driving device of any type of cable, chain, rope, etc. for driving the slow panels in opposition may be positioned in a horizontal loop between said guide tracks or adjacent to that of the slow panels and the relative driving device for the telescopic fast and slow panels, may be mounted on the slow panel carriage, advantageously with a belt mounted as a loop over the width of the slow carriage and suitably connected to the lintel and to the fast carriage.

Each of the panels naturally has a reduced thickness, equal to about 12 mm for example, without the smokeproof set of baffles and the play space, so that the thickness of a set of doors comprising the supporting lintel and the lower corresponding doorstep is equal to about 50 mm at the most, and the available space behind the unique panel is also of this order (50 mm) without the space.

The invention is illustrated hereafter by an exemplary embodiment and with reference to the appended drawings wherein:

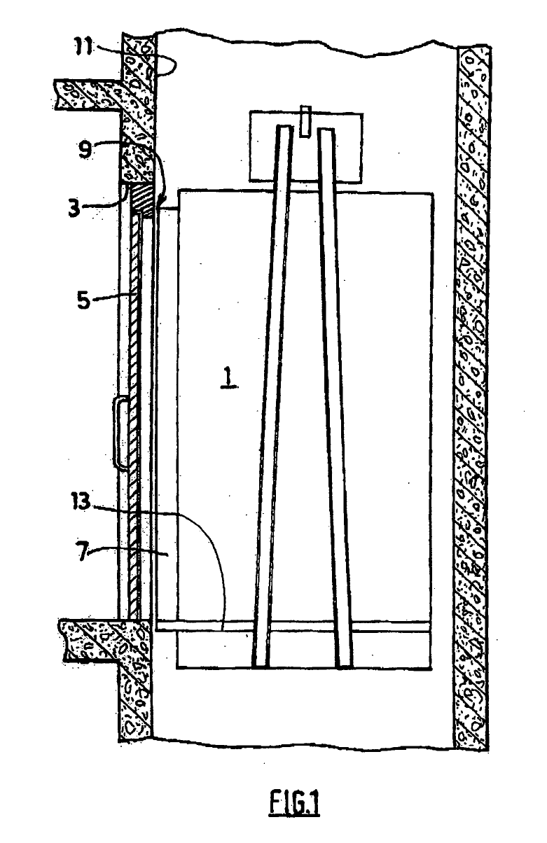

FIG. 1 is a side sectional view of an elevator car with swing doors to be replaced facing a storey landing access,

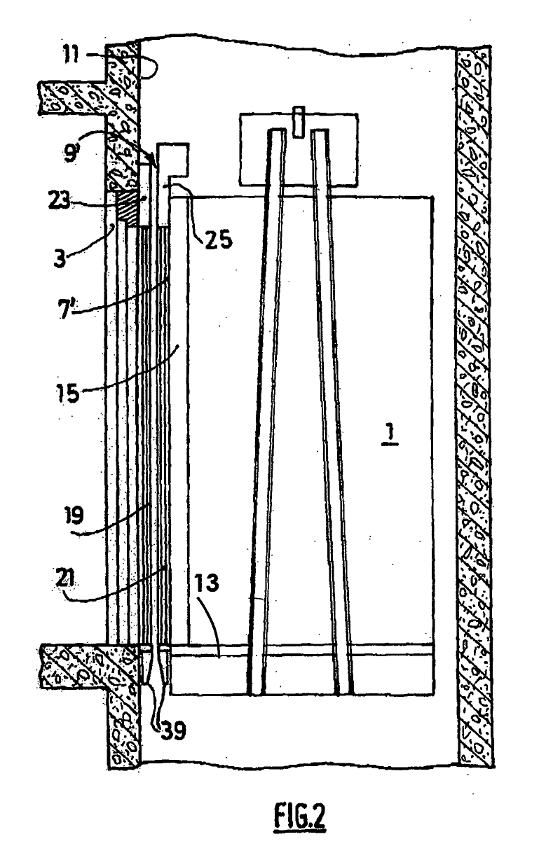

FIG. 2 is an analogous view to the previous one, showing a mounted assembly of landing doors and elevator car doors according to an exemplary embodiment of the invention,

FIG. 3 is a top sectional view showing the doors in the open position,

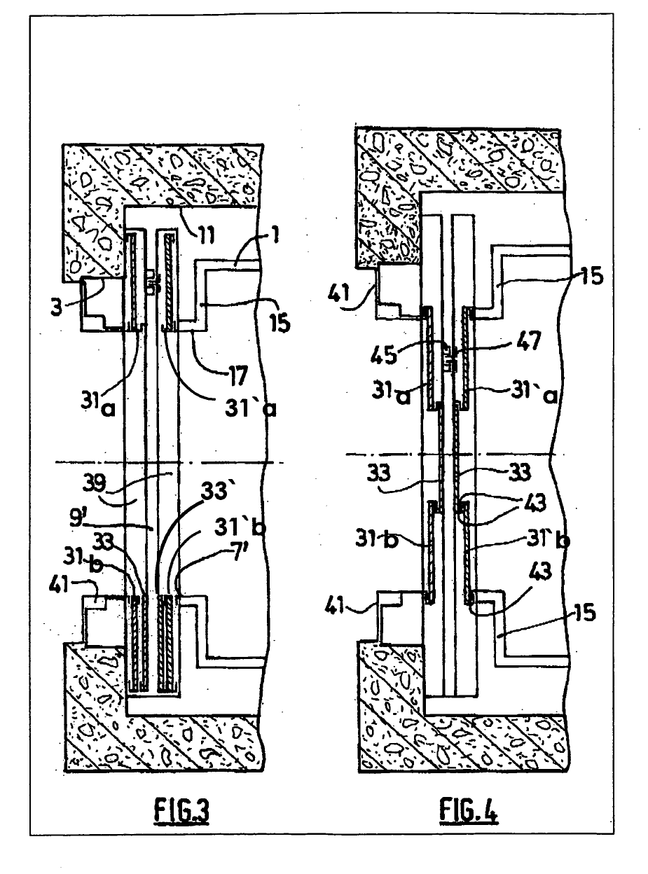

FIG. 4 is an analogous view with the doors in the closed position,

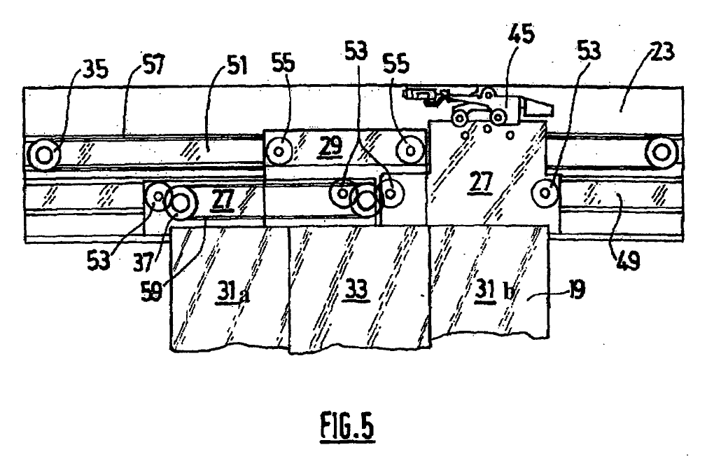

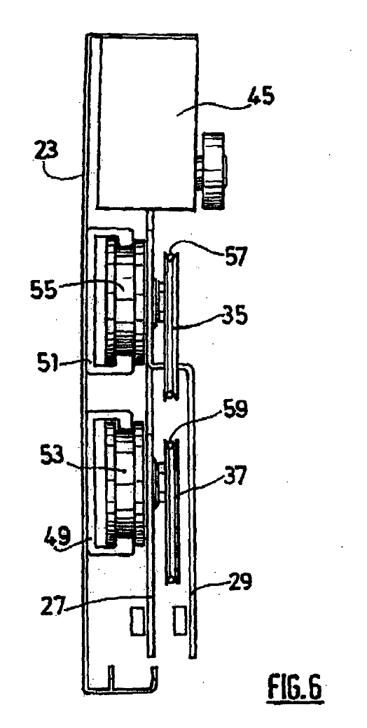

FIG. 5 is an elevational view of a supporting lintel of landing doors, and

FIG. 6 is a side view of this lintel.

FIG. 1 shows an elevator car 1, the landing access 3 of which is fitted with a swing door 5 which is to be replaced with a set of panel doors according to the invention.

The car 1 does not comprise any door and includes a front wall 7 extending towards the landing access 3 up to the normal translational space 9 of the car 1 in its shaft 11. This front wall 7 may advance by about 100 mm from the frame 13 of the car, the translational space 9 of the car being of about 25 mm for example. This front wall 7 may be cut out quite easily, without damaging the structural integrity of the car 1 and be replaced with a new front wall 7′ (FIGS. 2-4) notably provided with entrance columns 15 adapting the entrance opening 17 of the car to the width of the car.

In the cut-out space of the car front wall 7 and frontward from the new front wall 7′, a set of landing doors 19 and elevator car doors 21 according to the invention, may be mounted (FIG. 2).

The set of landing doors 19 is mounted just behind the landing access opening frame 3. The set of car doors 21 with a configuration analogous to the set of landing doors 19 is mounted on the adapted car front wall 7′ facing the set of landing doors 19. The space 9′ between the landing doors 19 and the car doors 21 has been maintained to about 25 mm.

Each set of doors 19, 21 is provided with an upper lintel, 23 and 25, respectively, each comprising the supporting carriages 27, 29 (FIG. 5) of the door panels, the slow ones 31a, 31b; 31′a, 31′b and the fast one 33; 33′ respectively, as well as their device 35; 37 for driving the slow panels 31a, 31b; 31′a, 31′b and the fast panel 33; 33′ by the slow one, respectively, and with a part of the doorstep 39 in the grooves of which the doors are linearly guided by suitable doorstep glides (not shown).

Of course, the fast panel 33, 33′ travels approximately twice as fast as the slow panel 31b, 31b′ so that the fast panel 33, 33′ and the slow panel 31b, 31b′ reach the open position at about the same time.

FIGS. 3 and 4 illustrate a top sectional view of the set of doors 19, 21 according to the invention, in the open position and in the closed position, respectively.

Each set of landing doors 19 and car doors 21 includes a layout facing them, of a panel 31a, 31′a and of two telescopic panels 31b, 31′b; 33, 33′ positioned face-to-face and edge-to-edge, respectively.

The panels 31a, 31b, 33; 31′a, 31′b, 33′ have a width equal and close to the third of the door opening width, for example about 280 mm for an opening of width about 800 mm, opening edge-to-edge facing each other simultaneously and closing in the same way with a small overlap over each other.

The opening of the doors is delimited on the side of the landing access opening 3 by trim cases 41 mounted on the frame sides of the landing access opening 3 and facing the car opening, and is delimited by the side edge of the open panels 31a, 31b, 33; 31′a, 31′b, 33′ (FIG. 3). Also, the entrance columns 15 of the car are mounted in the angles of the front wall 7′ of the car, delimiting the opening of the car 17 at right angles to the side edge of the open car panels 31a, 31b, 33; 31′a, 31′b, 33′.

Both of the unique door panels 31a, 31′a are positioned on the (upper) left side of the door in FIGS. 3 and 4, and because of their small width, they easily retract upon opening into the available side space in the shaft 11 behind the landing access 3. Both pairs of telescopic door panels 31b; 33; 31′b; 33′ are positioned on the right (at the lower level) and also retract together upon opening, into the landing access 3 rear right space in the shaft 11.

The panels 31a, 31b, 33; 31′a, 31′b, 33′ have a small thickness, of about 12 mm and both telescopic panels with their side baffle components 43 and the space between the panels, have a total thickness not exceeding about 50 mm. The same applies to the supporting lintels of the doors 23, 25 and to the entrance doorsteps 39, the thickness of which is less than or equal to about 50 mm.

The unique panels 31a, 31′a are positioned on the outside, one frontward and the other rearward facing each other, each being translated in the same plane as the corresponding slow panel 31b, 31′b of both sets of telescopic panels. They are thereby maximally spaced out from each other, housing in the available facing space (FIG. 4) the lock 45 with wheels for the landing doors' and the cam coupling device 47 for the car doors'.

A landing door lintel 23 is illustrated in FIGS. 5 and 6. The panels 31a, 33, 31b are illustrated in the closed position in FIG. 5. The slow panels 31a, 31b are suspended by their supporting carriage 27 on a lower horizontal guide rail 49 of the lintel. The fast panel 33 of the set of telescopic panels is suspended by its supporting carriage 29 from an upper horizontal guide rail 51 of the lintel. Because of this suspension on two guide rails 49, 51, the wheels 53, 55 of the slow 27 and fast 29 supporting carriages, respectively, were able to be moved away from each other by a distance considerably larger than the conventional one, slightly less than the width of the panel. This distance of the carriage wheels 53, 55 is slightly less than one and the half times the width of the panel and improves the guiding and stability of the panels.

The device 35 for simultaneously driving the slow panels in opposition is advantageously of the belt type 57 connected to the panels, positioned as a horizontal longitudinal loop and extending adjacent (FIG. 6) to the upper rail and over the length of the lintel 23.

The relative driving device 37 of the telescopic panels is also of the belt type 59 mounted as a horizontal loop on the slow carnage 27 over its width, and adjacent to the lower rail 49. The belt 59 is conventionally connected to the fast carriage 29 and to the lintel 23 and drives the fast carriage 29 simultaneously with the slow carriage 27, with speed and displacement double of that of the slow carriage.

Of course, the devices 35, 37 can be of any type of cable, chain, rope, belt, etc.

The thickness of the lintel 23 with its components (FIG. 6) and also of the lintel 25 is also about 50 mm at the most in order to allow sufficient space 9′ (about 25 mm) for the passage of the car in the shaft.

The invention thereby provides elevator doors for refurbishment of existing elevators, which meets present security standards, and with accessible installation at a reasonable cost.

1. Elevator door comprising a door (19, 21), characterized in that the door (19, 21) is a three panel door and comprises a first panel (31a, 31a′) and two telescopic panels (31b, 33; 31b′, 33′) with a central opening, the door (19, 21) is positioned behind a landing access opening frame (3) and within a space between a car frame (13) and the landing access opening (3).

2. Elevator door according to claim 1, characterized in that the door includes a landing door (19) and/or a car door (21), the car door (21) is mounted on the elevator car and the landing door (19) and the car door (21) have the same configuration.

3. Elevator door according to claim 1 or 2, comprising a set of landing doors (19) and elevator car doors (21) as a replacement for existing swing doors (5) without requiring any substantial masonry work, any change in the structure of the car or in the displacement of the latter, the space between the car frame (13) and the landing access opening frame (3) being of about 125 mm at the most, characterized in that it comprises a set of landing doors (19) positioned just behind the landing access opening frame (3) and provided with a set of one panel (31a, 31′a) and two telescopic panels (31b, 33; 31′b, 33′) with a central opening, the total thickness of which is reduced, and a set of car doors (21) mounted on the elevator car, with a configuration analogous to the set of landing doors (19) and intended to come face-to-face with the latter, within the space (9′), at each building storey landing, in said space of about 125 mm between the car frame (13) and the landing access opening frame (3).

4. Elevator door according to claim 1-3, characterized in that a portion of the car front wall (7) may be cut out without reaching the car frame (13), by suitable adapting the space between landing doors (19) and car doors (21).

5. Elevator door according to any of the preceding claims 1 to 3, characterized in that a new car front wall (7′) may be mounted.

6. Elevator door according to any of the preceding claims, characterized in that said space (9′) between landing doors (19) and car doors (21) is standard, lying between about 15 and 35 mm, and preferably equal to about 25 mm, the thickness of each set of landing doors (19) and car doors (21) being of about 50 mm at the most.

7. Elevator door according to any of the preceding claims, characterized in that the door panels (31a, 33, 31b; 31′a, 33′, 31′b) have the same width.

8. Elevator door according to any of the preceding claims, characterized in that the use of three-panel doors (10, 21) with a central opening limits the length of the opening extension of the latter and therefore the space for setting up the latter behind the landing access opening frame (3).

9. Elevator door according to any of the preceding claims, characterized in that, in addition, with this configuration of doors with one and two telescopic panels (31a, 33, 31b; 31′a, 33′, 31′b) in opposition, an available space may be formed behind the unique panel (31a, 31′a) positioned frontward and used for housing behind the landing door panel (31a), the landing doors' lock components (45) and behind the car door panel (31′a), the coupling device (47) of car doors.

10. Elevator door according to any of the preceding claims, characterized in that the slow panels (31a, 31b; 31′a, 31′b) are driven by their supporting carriage (27) on a same track (49) of the corresponding supporting lintel (23, 25) and the fast panel (33, 33′) is driven by its supporting carriage (29) on a second track (51) of the lintel (23, 25) so that the wheels (53, 55) of these carriages may be positioned on each of these tracks more freely and therefore with a center distance notably larger than the conventional one, this increased center distance of the wheels (53, 55) improving the guiding and stability of the door panels (31; 33).

11. Elevator door according to any of the preceding claims, characterized in that the driving device (35) for the slow panels (31a, 31b; 31′a, 31′b) in opposition may be positioned as a horizontal loop between said guide tracks (49, 51) or adjacent to that of the slow panels and the relative driving device (37) of the telescopic fast (33, 33′) and slow (31a, 31b; 31′a, 31′b) panels may be mounted on the slow panel carriage (27) advantageously with a cable (59) mounted as a loop over the width of the slow carriage (27) and suitably connected to the lintel (23, 25) and to the fast carriage (29).

12. Elevator door according to any of the preceding claims, characterized in that each of the panels (31a, 33, 31b; 31′a, 33′, 31′b) has a reduced thickness, for example equal to about 12 mm, without the set of smoke-proof baffles (43) and play space, so that the thickness of a set of doors (19, 21) comprising the corresponding supporting lintel (23, 25) and the lower corresponding doorstep is equal to about 50 mm at the most, and the available space behind the unique panel (31) is also of that order to 50 mm without the space.
